(19) United States
(12) Patent Application Publication
(10) Pub. No.: US 2025/0262656 A1
(43) Pub. Date: Aug. 21, 2025

(54) A TOOL HEAD FOR MANUFACTURING A SEPARATION DISC AND A METHOD FOR MANUFACTURING A SEPARATION DISC USING A TOOL HEAD

(71) Applicant: Alfa Laval Corporate AB, LUND (SE)

(72) Inventor: Sven-Åke NILSSON, GNESTA (SE)

(73) Assignee: Alfa Laval Corporate AB, LUND (SE)

(21) Appl. No.: 18/859,483

(22) PCT Filed: Apr. 25, 2023
(86) PCT No.: PCT/EP2023/060740

§ 371 Date: Oct. 23, 2024

(30) Foreign Application Priority Data
May 16, 2022 (EP) 22173448.6

(51) Int. Cl. B21D 22/16; B21D 51/10

(52) U.S. Cl. CPC B21D 22/16; B21D 51/10

(57) ABSTRACT

A tool head for manufacturing a separation disc includes a ball element configured to bear on a work piece to form the separation disc on a rotating mandrel; a holding device for holding the ball element; and a fixating element for detachably and rotatably arranging the ball element at the holding device. A method for manufacturing a separation disc uses a tool head.

### TECHNICAL FIELD

The present disclosure relates to a tool head for manufacturing a separation disc and a method for manufacturing a separation disc using a tool head.

### BACKGROUND ART

Conical separation discs are used in centrifugal separators. Such separation discs can be made of thin sheet metal and be produced by spinning. The separation discs are provided with spacing means in the form of narrow strips or small circles of sheet metal which are fastened to the separation discs, for example by spot welding, in order to achieve a space between discs stacked on top of each other. Alternatively, the separation discs may be provided with integrally formed spacing means.

A known method for pressing separation discs with integrally formed elevations involves flow forming of a sheet metal blank or workpiece over a mandrel to produce a separation disc with integrally formed elevations. The workpiece is pressed over the mandrel by means of a roll, which exerts a large pressure on the workpiece. The mandrel is provided with depressions, which during the flow forming of the workpiece become filled with material from the blank.

In making separation discs with integrally formed elevations by flow forming of a workpiece or workpiece over a mandrel, the elevations should exceed a certain height in order to achieve the space between the discs stacked on top of each other. This is achieved by filling the depressions in the mandrel during the flow forming of the workpiece.

Document EP2886217 A1 discloses a method for manufacturing a separation disc, starting from a metal sheet blank with a top side and a bottom side. Said metal sheet blank is provided extra metal material in positions on its top side. Aligning the metal sheet blank so that the positions of the extra metal material after said pressing will correspond to depressions in the mandrel, will after flow forming the metal sheet blank by means of a roller fill the depressions and thus complete the elevations on the separation disc.

### SUMMARY

A problem with the solution of the prior art is that elevations may not reach a certain height, since the method may not fill the depressions completely. A further problem is that the solution of the prior art uses a roller, which may not complete the separation discs satisfactorily. Further problems to be solved are that vibrations may be raised when the workpiece is pressed over the mandrel by means of the roll, that a tool head together with the roll must be replaced when the roll is worn out, and that that roll may cause a breakdown of the tool head due to large heat generation when the workpiece is pressed over the mandrel by means of the roll.

There is thus a need for improved tool and a method of producing a separation discs by flow forming of a workpiece over a mandrel.

Despite known solutions in the field, it would be desirable to develop a tool head and a method for manufacturing a separation disc, which overcome or alleviate at least some of the drawbacks of the prior art.

It is an object of the present invention to mitigate, alleviate or eliminate one or more of the above-identified deficiencies and disadvantages in the prior art and solve at least the above-mentioned problem.

An objective of the present invention is thus to achieve a tool head and a method for manufacturing a separation disc, which complete the separation discs satisfactorily.

A further objective of the present invention is to achieve a tool head and a method for manufacturing a separation disc, which reduces vibrations that may arise when the workpiece is pressed over the mandrel by means of the tool head.

A further objective of the present invention is to achieve a tool head and a method for manufacturing a separation disc, which eliminates the need to replace the complete tool head during maintenance.

A further objective of the present invention is to achieve a tool head and a method for manufacturing a separation disc, which dissipates heat from the tool head, which is generated during the manufacturing of the separation disc.

These objectives are achieved with the above-mentioned a tool head and a method for manufacturing a separation disc according to the appended claims.

According to a first aspect there is provided a tool head for manufacturing a separation disc, the tool head comprises: a ball element configured to bear on a work piece to form the separation disc on a rotating mandrel; and a holding device for holding the ball element; wherein the tool head further comprises a fixating element for detachably and rotatably arrange the ball element at the holding device.

Such tool head for manufacturing a separation disc will complete the separation discs satisfactorily due to the ball element, which is configured to bear on the work piece to form the separation disc on a rotating mandrel. Due to the combination of the ball element, the holding device and the fixing element, vibrations that may arise when the workpiece is pressed over the mandrel by means of the tool head can be reduced. Due to the fixating element, which detachably and rotatably arrange the ball element at the holding device, replacement of the complete tool head during maintenance is eliminated. Further, heat generated during the manufacturing of the separation disc can effectively be dissipated from the tool head.

According to a second aspect, there is provided a machine tool for manufacturing a separation disc. The machine tool comprises a tool head according to the first aspect and a container for pressure fluid that is fluidly connected to the tool head via conduit. The pressure fluid may be oil, i.e. the container may comprise oil that may be delivered to the tool head via the conduit. The machine tool may for example be a robotic arm. The container may thus also be arranged for pressurizing the pressure fluid. The machine tool may be arranged so as to provide a pressure of above 300 bar, such as between 300-700 bar, such as between 300-500 bar, onto the ball element of the tool head.

According to a third aspect there is provided a method for manufacturing a separation disc using a tool head according to the first aspect claims, wherein the tool head comprises: a ball element configured to bear on a work piece to form the separation disc on a rotating mandrel; a holding device for holding the ball element; and a fixating element for detachably and rotatably arrange the ball element at the holding device; wherein the method comprises the steps of: rotating the mandrel for rotating the work piece; positioning the tool head to bear with the ball element on the work piece; activating a fluid pressure on the ball element; and feeding the tool head along a surface of the work piece to finish the separation disc.

The method for manufacturing a separation disc using the above-mentioned tool head will complete the separation discs satisfactorily due to the ball element, which is configured to bear on the work piece to form the separation disc on a rotating mandrel. Vibrations that may arise when the workpiece is pressed over the mandrel by means of the tool head can be reduced by the method. Further, heat generated during the manufacturing of the separation disc can effectively be dissipated from the tool head by using the method.

Additional objectives, advantages and novel features of the invention will be apparent to one skilled in the art from the following details, and through exercising the invention. While the invention is described below, it should be apparent that the invention may not be limited to the specifically described details. One skilled in the art, having access to the teachings herein, will recognize additional applications, modifications and incorporations in other areas, which are within the scope of the invention.

### BRIEF DESCRIPTIONS OF THE DRAWINGS

For fuller understanding of the present disclosure and further objects and advantages of it, the detailed description set out below should be read together with the accompanying drawings, in which the same reference notations denote similar items in the various figures, and in which:

FIG. 1 schematically illustrates a side view of a tool head for manufacturing a separation disc on a rotating mandrel according to an example;

FIG. 2 schematically illustrates a side view of a tool head according to an example;

FIG. 3 schematically illustrates a section view of an assembled tool head according to an example;

FIG. 4 schematically illustrates a section view of a disassembled tool head according to an example;

FIG. 5 schematically illustrates a side view of a disassembled tool head according to an example; and

FIG. 6 shows a flowchart of a method for manufacturing of a separation disc using a tool head according to an example.

### DETAILED DESCRIPTION

The detailed description with reference to the examples depicted are to be viewed as examples comprising a combination of certain features, which features have been described in detail above. It is thus to be understood that additional examples may be achieved by combining other features into examples not depicted herein. The figures are to be viewed as examples and not mutually exclusive combinations. It should also be noted that all figures shown and described are schematically represented, wherein generic parts of machinery or similar is not depicted for the sake of simplicity.

According to a first aspect there is provided a tool head for manufacturing a separation disc, the tool head comprises: a ball element configured to bear on a work piece to form the separation disc on a rotating mandrel; and a holding device for holding the ball element; wherein the tool head further comprises a fixating element for detachably and rotatably arrange the ball element at the holding device. The tool head may be configured to resist large forces and high pressures. Further, the tool head may be provided with connection elements for connection to a machine tool, to pressurized fluid and to electronics, such as control devices and sensors. The completed separation disc, which is manufactured by the tool head may have high tolerances, and high surface finish. The separation disc may be made from a work piece of metal. The work piece may be a flat, circular disc of metal. The completed separation disc may have a frustoconical shape, which conical portion corresponds to a conical shape of the rotating mandrel. Thus, the rotating mandrel has a conical shape. The conical shape may correspond to a truncated cone. The rotating mandrel may have a conical mantle surface. The conical mantle surface may be support surface for the workpiece. The ball element may be a homogeneous or a hollow sphere. The ball element may comprise a heat dissipating material, such as steel or metal. The ball element may be heat treated and hardened. In order to form the work piece on the mandrel, the ball element should bear on the work piece with a large force and a high pressure. The ball element may be rotatably arranged in the holding device. The fixating element may secure the position of the ball element in the holding device and provide the ball element to rotate in relation to the fixating element. The ball element may be detached from the holding device by releasing and removing the fixating element from the holding element. The ball element can be cleaned or replaced when the fixating element is removed from the holding element.

The fixating element may be detachably arranged on the holding device by a threaded joint. The threaded joint will firmly and releasably fixate the fixating element on the holding device. By unscrewing the fixating element from the holding device, the ball element can be removed from the holding device. A removed ball element may be cleaned or replaced if worn out. When the ball element is returned into the holding device or a new ball element is mounted into the holding device, the fixating element is screwed on the holding device. When the fixating element is screwed on the holding device, the ball element is allowed to rotate in relation to the fixating element and the holding device.

The fixating element may comprise an opening, through which a part of the ball element is configured to protrude. The part of the ball element, which protrudes from the fixing element is configured to bear on the work piece to form the separation disc on a rotating mandrel. The opening may be circular. The diameter of the circular opening is smaller than the diameter of the ball element. This prevents the ball element to fall out of the circular opening.

The fixating element may comprise gripping elements configured for tightening and loosening the fixating element at the holding device. The gripping elements may be grabbed by hand or by a tool. The gripping elements entails that a large torque may be applied to the fixating element, both for tightening and loosening the fixating element to the holding device.

The holding device may comprise a cavity for at least partly accommodating the ball element. The cavity may fixate the position of the ball element. The cavity may protect the ball element from external influence outside the holding device. The cavity may be a reservoir for pressure fluid.

The holding device may be provided with a first control surface and the fixating element is provided with a second control surface, which control surfaces are configured to control the position of the ball element. The control surfaces may have a convex shape adapted to the spherical shape of the ball element. The control surfaces may be configured as plain bearings, so that the ball element may slide on the control surfaces.

The holding device may comprise a fluid channel for providing pressure fluid on the ball element. The pressure fluid may be provided on the ball element. The pressure fluid may be provided at the boundary between the ball element and the control surfaces. The pressure fluid may create a layer between the ball element and the control surfaces, which allows the ball element to rotate in relation to the control surfaces. The pressure fluid may also flow on and past the ball element in order to dissipate heat and to lubricate the contact surfaces between the workpiece and the ball element. The flow of the pressure fluid may also transport any debris from the ball element. The pressure fluid may be provided to the ball element under high pressure. The pressure of the pressure fluid may be above 300 bar, such as between 300-700 bar, such as between 300-500 bar or in the range of 500 to 700 bar.

The fluid channel may extend to the cavity for at least partly accommodating the ball element. The cavity may be larger than the ball element such that the cavity functions as a reservoir for pressure fluid behind the ball element. This may provide for exerting a high pressure on the ball element. The reservoir for pressure fluid may thus be a volume opposite the workpiece that is being processed by the tool head, i.e. on the other side of the ball element as compared to the workpiece during use of the tool head.

The fixating element may comprise at least one outlet channel for the pressure fluid. The outlet channel may be positioned so that the pressure fluid passes the ball element and the control surfaces. The outlet channel may be positioned in the second control surface of the fixating element. The outlet channel is configured to open in an outside surface of the fixating element. A number of outlet channels may be arranged in the second control surface.

The outlet channels can be placed at equal distances from each other in order to distribute the pressure fluid equally over the ball element and the control surfaces.

The ball element may be made of a heat dissipating material. Heat generated during the manufacturing of the separation disc can effectively be dissipated from the tool head and the ball element if the ball element is made of a heat dissipating material. Such heat dissipating material may be steel or metal.

The ball element may have a spherical shape with a diameter D in the range of 10-40 mm, and preferably 15-30 mm. A ball element with such diameter D may effectively complete the separation discs satisfactorily. A ball element with such diameter D may fill depressions in the surface of the mandrel completely, so that elevations exceeding a certain height is produced, which elevations create a space between the discs stacked on top of each other.

The tool head is configured to be connected to a machine tool, which is connected to a control device. Thus, as an aspect of the invention, there is provided a machine tool for manufacturing a separation disc. The machine tool comprises a tool and a container for pressure fluid that is fluidly connected to the tool head via conduit. The pressure fluid may be oil, i.e. the container may comprise oil that may be delivered to the tool head via the conduit. The machine tool may for example be a robotic arm. The machine tool may be configured to be controlled by the control device. The machine tool may be a robot arm. During the rotation of the mandrel and the work piece, the ball element is pressed against the work piece and is caused by friction to rotate or roll against the work piece and is guided axially along and at a chosen distance from the support surface so that the work piece is gradually moved along a helicoidal path to abut against the support surface of the mandrel. This movement of the tool head and the ball element may be controlled by the control device.

According to an aspect there is provided a method for manufacturing a separation disc using a tool head according to the first aspect claims, wherein the tool head comprises: a ball element configured to bear on a work piece to form the separation disc on a rotating mandrel; a holding device for holding the ball element; and a fixating element for detachably and rotatably arrange the ball element at the holding device; wherein the method comprises the steps of: rotating the mandrel for rotating the work piece; positioning the tool head to bear with the ball element on the work piece; activating a fluid pressure on the ball element; and feeding the tool head along a surface of the workpiece to finish the separation disc. Rotating the mandrel for rotating the work piece may be performed by a motor. The motor may be an electric driven motor. The motor may be connected to a control device. The control device may control the rotational speed and torque of the motor. Positioning the tool head to bear with the ball element on the work piece comprises positioning the ball element of the tool head so it bears and abuts with a pressure on the side of the work piece, which faces away from the support surface of the mandrel. In the beginning of the process, the work piece may rest on the mandrel, so that a part of the workpiece is arranged at a distance from the support surface of the mandrel. The pressure from the ball element of the tool head acting on the work piece will shape that a part of the workpiece, which is arranged at a distance from the support surface of the mandrel, so that the workpiece will take the similar shape as the conical shape of the mandrel. Activating a fluid pressure on the ball element may comprise providing a pressure fluid through the fluid channel in the holding device. The pressure of the pressure fluid may be above 300 bar, such as between 300-700 bar, such as between 300-500 bar or in the range of 500 to 700 bar. The pressure fluid may create a layer between the ball element and the control surfaces, which allows the ball element to rotate in relation to the control surfaces. Feeding the tool head along a surface of the work piece to finish the separation disc comprises guiding the ball element of the tool head axially along and at a chosen distance from the support surface, so that the work piece is gradually moved along a helicoidal path to abut against the support surface. The force from the ball element will move the material from the work piece onto the support surface and into said recesses in the support surface. When the ball element is pressed against the work piece and moved along the support surface, the separation disc will be completed and finished by flow forming of the work piece by means of the ball element and the mandrel with spacing members on a bottom side of the separation disc.

The step of positioning the tool head to bear with the ball element on the workpiece may comprise controlling the orientation of the holding device, so that a centerline of the holding device is parallel to a normal of the surface of the finished separation disc. When the centerline of the holding device is parallel to a normal of the surface of the finished separation disc and thus of the support surface of the mandrel, the ball element can act with a high pressure on the workpiece.

The method may further comprise a step of determining the condition of the ball element. A vibration sensor may be arranged at the tool head. The vibration sensor may detect vibrations, which emanates from the ball element during rotation on the workpiece. The vibration sensor may be connected to the control device.

The method may further comprise a step of replacing the ball element, based on the determined condition of the ball element, by removing the fixating element and detaching the ball element. The condition of the ball element may be determined based on vibrations generated from the ball element during rotation on the workpiece. The vibration sensor may detect the vibrations. When the frequency and/or the amplitude of the vibrations has reached a certain level, the ball element may be replaced. The control device may be configured to send an alarm to an operator, indicating that the ball element should be replaced. The operator removes the fixating element and detaches the ball element. Thereafter, the operator replaces the ball element with a new ball element.

The present disclosure will now be further illustrated with reference to the appended figures.

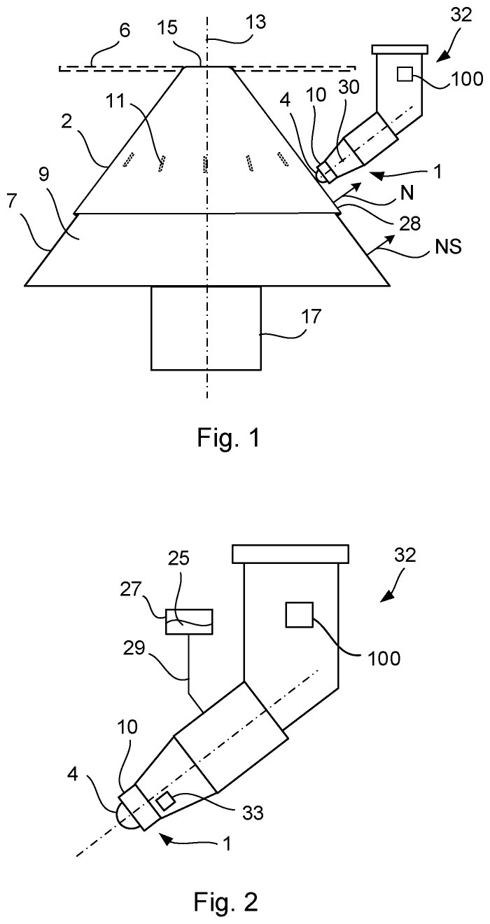

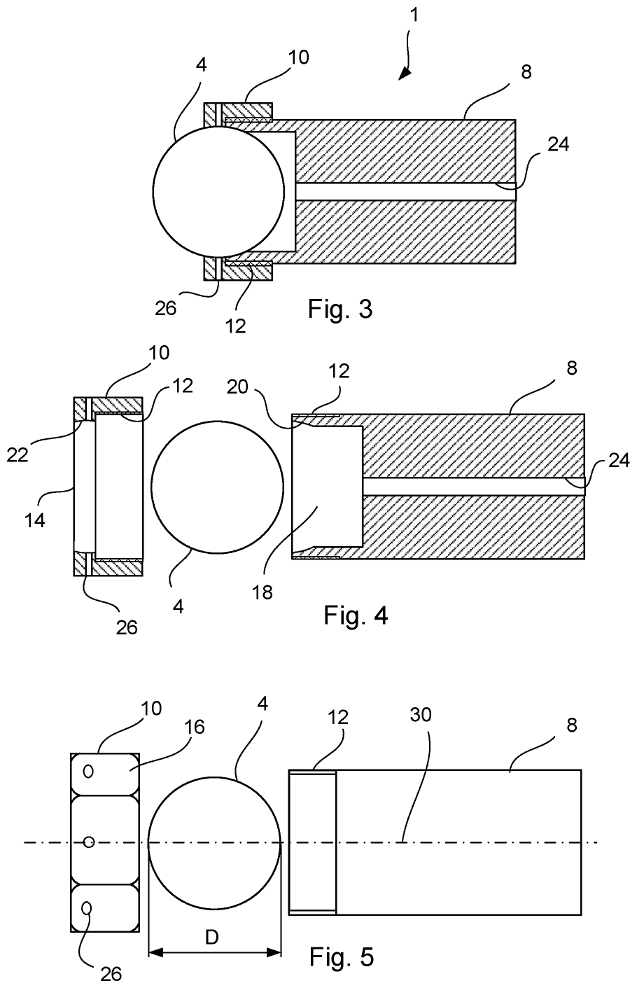

FIG. 1 schematically illustrates a side view of a tool head 1 for manufacturing a separation disc 2 on a rotating mandrel 7 according to an example. The tool head 1 comprises a ball element 4, which is configured to bear on a work piece 6 of the separation disc 2. The tool head 1 further comprises a holding device 8 (FIG. 3) for holding the ball element 4 and a fixating element 10 for detachably and rotatably arrange the ball element 4 at the holding device 8.

The mandrel 7 comprising a truncated conical support surface 9, which may comprise recesses 11 corresponding to spacing members on the completed separation disc 2. The work piece 6 is caused to abut firmly against said mandrel 7 transversely to a geometric axis 13 at one axial end 15 of the conical support surface 9, and the mandrel 7 and the work piece 6 being caused to rotate at the same speed about the geometric axis 13. A motor 17 connected to the mandrel 7 is arranged to rotate the mandrel 7.

The ball element 4 of the tool head 1 bears and abuts with a pressure on the side of the work piece 6, which faces away from the support surface 9 of the mandrel 7. During the rotation of the mandrel 7 and the work piece 6, the ball element 4 is pressed against the work piece 6 and is caused by friction to rotate or roll against the work piece 6, and is guided axially along and at a chosen distance from the support surface 9, so that the work piece 6 is gradually moved along a helicoidal path to abut against the support surface 9, with such force that material from the work piece 6 moves onto the support surface 9 and into said recesses 11 in the support surface 9. When the ball element 4 is pressed against the work piece 6 and moved along the support surface 9, the separation disc 2 will be completed by flow forming of the work piece 6 by means of the ball element 4 and the mandrel 7 with spacing members on a bottom side of the separation disc 2.

The tool head 1 may be positioned to bear with the ball element 4 on the work piece 6, so that a centerline 30 of the holding device 8 is parallel to a normal N of the surface 28 of the finished separation disc 2. The normal N of the surface 28 of the finished separation disc 2 is parallel to a normal NS of the support surface 9 of the mandrel 7.

FIG. 2 schematically illustrates a side view of a tool head according to an example. The tool head 1 may be configured to be connected to a machine tool 32, such as a robot arm. A control device 100 may be connected to the machine tool 32 for controlling the movement of the machine tool 32. Further, the control device 100 may be configured to determine the condition of the ball element 4. Pressure fluid 25 may be supplied to the tool head 1 from a container 27, which is fluidly connected to the tool head 1 via a conduit 29. The control device 100 may also control the rotational speed and torque of the motor 17 (FIG. 1). A vibration sensor 33 may be arranged at the tool head.

FIGS. 3-5 schematically illustrates the tool head 1 in different views. In FIG. 3, the tool head 1 is disclosed assembled in a section view. In FIG. 4, the tool head 1 is disclosed disassembled in a section view. In FIG. 5 the tool head 1 is disclosed disassembled in a side view. When assembled, the fixating element 10 is detachably arranged on the holding device 8 by a threaded joint 12. The fixating element 10 comprises an opening 14 through which a part of the ball element 4 is configured to protrude. The fixating element 10 comprises gripping elements 16 configured for tightening and loosening the fixating element 10 at the holding device 8.

The holding device 8 comprises a cavity 18, which at least partly is configured to accommodate the ball element 4. The holding device 8 is provided with a first control surface 20 and the fixating element 10 is provided with a second control surface 22, which control surfaces 20, 22 are configured to control the position of the ball element 4. Further, the holding device 8 comprises a fluid channel 24 for providing pressure fluid 25 (see FIG. 2) on the ball element 4. The fixating element 10 comprises at least one outlet channel 26 for the pressure fluid 25.

The ball element 4 may have a spherical shape with a diameter D in the range of 10-40 mm, and preferably 15-30 mm. Further, the ball element 4 may be made of a heat dissipating material.

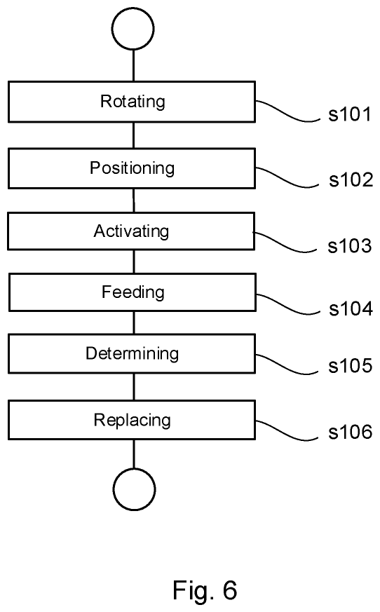

FIG. 6 shows a flowchart of a method for manufacturing of a separation disc using a tool head according to an example. The method relates to the manufacturing of a separation disc using a tool head disclosed in FIGS. 1-5. The method comprises the steps of rotating s101 the mandrel 7 for rotating the work piece 6; positioning s102 the tool head 1 to bear with the ball element 4 on the work piece 6; activating s103 a fluid pressure on the ball element 4; and feeding s104 the tool head 1 along a surface 28 of the work piece 6 to finish the separation disc 2.

The step of positioning s102 the tool head 1 to bear with the ball element 4 on the work piece 6, comprises controlling the orientation of the holding device 8, so that a centerline 30 of the holding device 8 is parallel to a normal N of the surface 28 of the finished separation disc 2.

The method comprises the further step of determining s105 the condition of the ball element 4.

The method comprises the further step of replacing s106 the ball element 4, based on the determined condition of the ball element 4, by removing the fixating element 10 and detaching the ball element 4.

The foregoing description of the embodiments has been furnished for illustrative and descriptive purposes. It is not intended to be exhaustive, or to limit the embodiments to the variations described. Many modifications and variations will obviously be apparent to one skilled in the art. The embodiments have been chosen and described in order to best explicate principles and practical applications, and to thereby enable one skilled in the art to understand the invention in terms of its various embodiments and with the various modifications that are applicable to its intended use. The components and features specified above may, within the framework of the disclosure, be combined between different embodiments specified.

1. A tool head for manufacturing a separation disc, the tool head comprising:
a ball configured to bear on a work piece to form the separation disc on a rotating mandrel;
a holder configured to hold the ball; and
a fastener configured to detachably and rotatably arrange the ball element at the holder.

2. The tool head according of claim 1, wherein the fastener is detachably arranged on the holder by a threaded joint.

3. The tool head according to claim 1, wherein the fastener comprises an opening through which a part of the ball is configured to protrude.

4. The tool head according to claim 1, wherein the fastener comprises grippers configured for tightening and loosening the fastener at the holder.

5. The tool head according to claim 1, wherein the holder comprises a cavity for at least partly accommodating the ball.

6. The tool head according to claim 1, wherein the holder is provided with a first control surface and the fastener is provided with a second control surface, the first and second control surfaces being configured to control a position of the ball.

7. The tool head according to claim 1, wherein the holder comprises a fluid channel for providing pressure fluid on the ball.

8. The tool head according of claim 7, wherein the fastener comprises at least one outlet channel for the pressure fluid.

9. The tool head according to claim 5, wherein the holder comprises a fluid channel for providing pressure fluid on the ball,
wherein the fluid channel extends to the cavity, and
wherein the cavity is larger than the ball such that the cavity functions as a reservoir for pressure fluid behind the ball.

10. The tool head according to claim 1, wherein the ball is made of a heat dissipating material.

11. The tool head according to claim 1, wherein the ball has a spherical shape with a diameter in the range of 10-40 mm.

12. The tool head according to claim 1, wherein the tool head is configured to be connected to a machine tool, the machine tool being connected to a controller, and wherein the machine tool is configured to be controlled by the controller.

13. A machine tool for manufacturing a separation disc, comprising:
the tool head according to claim 1; and
a container for pressure fluid that is fluidly connected to the tool head via a conduit.

14. A method for manufacturing a separation disc using the tool head according to claim 1,
wherein the method comprises the steps of:
rotating the mandrel for rotating the work piece;
positioning the tool head to bear with the ball on the work piece;
activating a fluid pressure on the ball; and
feeding the tool head along a surface of the work piece to finish the separation disc.

15. The method according to claim 14, wherein the step of positioning the tool head to bear with the ball on the work piece, comprises controlling an orientation of the holder, so that a centreline of the holder is parallel to a normal of the surface of the finished separation disc.

16. The tool head according to claim 1, wherein the ball has a spherical shape with a diameter in the range of 15-30 mm.

17. The tool head according to claim 2, wherein the fastener comprises an opening through which a part of the ball is configured to protrude.

18. The tool head according to claim 2, wherein the fastener comprises grippers configured for tightening and loosening the fastener at the holding device.

19. The tool head according to claim 3, wherein the fastener comprises grippers configured for tightening and loosening the fastener at the holding device.

20. The tool head according to claim 2, wherein the holder comprises a cavity for at least partly accommodating the ball.
